(19) United States
(12) Patent Application Publication
(10) Pub. No.: US 2011/0122294 A1
(43) Pub. Date: May 26, 2011

(54) DIGITAL PHOTOGRAPHING APPARATUS, METHOD OF CONTROLLING THE SAME, AND RECORDING MEDIUM STORING PROGRAM TO EXECUTE THE METHOD

(75) Inventors: Inh-seok Suh, Yongin-si (KR); Seung-yun Lee, Hwaseong-si (KR)

(73) Assignee: Samsung Electronics Co., Ltd., Suwon-si (KR)

(21) Appl. No.: 12/950,032

(22) Filed: Nov. 19, 2010

(30) Foreign Application Priority Data
Nov. 20, 2009 (KR) 10-2009-0112786

(51) Int. Cl. H04N 5/225

(52) U.S. Cl. 348/231.99; 348/E05.024

(57) ABSTRACT

Provided are a digital photographing apparatus, a method of controlling the digital photographing apparatus, and a computer readable recording medium storing a program for executing the method. The digital photographing apparatus may include a database configured to store information about a person and to store a plurality of images of the face of the person with a direction of the face; a photographing unit configured to photograph an image of the face of the person; an image registering unit configured to store the photographed image of the face of the person with the database according to the direction of the face; and a photographing guide unit configured to display a direction of the face of the person not stored in the database.

### CROSS-REFERENCE TO RELATED PATENT APPLICATION

This application claims the benefit of Korean Patent Application No. 10-2009-0112786, filed on Nov. 20, 2009, in the Korean Intellectual Property Office, the entire disclosure of which is incorporated herein by reference.

### BACKGROUND

1. Field of the Invention

Embodiments of the invention relate to a digital photographing apparatus, a method of controlling the same, and a recording medium storing a program for executing the method.

2. Description of the Related Art

Recent digital photographing apparatuses such as digital cameras, digital camcorders, etc. are capable of determining whether a face of a person is included in an image. The digital photographing apparatuses often perform an auto-focusing (AF) function using based on the detected face.

Face recognition may be important to a user of a digital photographing apparatus due to the features it enables including auto-focusing.

### SUMMARY

Therefore, there is a need in the art for a digital photographing apparatus capable of performing an improved face recognition function, a method of controlling the digital photographing apparatus, and a recording medium storing a program for executing the method.

According to an aspect of the invention, there is provided a digital photographing apparatus including a database configured to store information about a person and to store a plurality of images of the face of the person with a direction of the face; a photographing unit configured to photograph an image of the face of the person; an image registering unit configured to store the photographed image of the face of the person with the database according to the direction of the face; and a photographing guide unit configured to display a direction of the face of the person not stored in the database.

The photographing guide unit may include a first direction determining unit configured to determine directions of the face that are not stored in the database; and a direction display unit configured to display the directions of the face that are not stored in the database.

The photographing guide unit may be configured to display a plurality of stored photographed images of the face according to the direction of the face.

The photographing guide unit may be configured to display the plurality of stored photographed images of the face as thumbnail images.

The digital photographing apparatus may include a face detection unit configured to detect the face in the photographed image of the face of the person; and a person recognition unit configured to determine whether the person is stored in the database based on at least two photographed images of the face of the person with different directions.

The photographing guide unit may be configured to display a direction of the face that is not stored in the database.

The digital photographing apparatus may include a second direction determining unit configured to determine the direction of the face of the photographed image, and wherein the image registering unit is configured to store the photographed image of the face if the direction of the face of the photographed image is not stored in the database.

The direction of the face may include a front, above, below, left, and right all with respect to the face of the person.

According to another aspect of the invention, there is provided a method of controlling a digital photographing apparatus comprising a database comprising information about a person and a face image of the person, capable of storing a plurality of face images of the person photographed in different directions, the method comprising: a) photographing an image of a subject; b) displaying a non-registered direction of a face image in the database, to the photographer; and c) registering the photographed image to the database.

b) may comprise: b-1) determining a non-registered direction of a face image with respect to a person whose face image is to be registered to the database; and b-2) displaying a direction of the face image that is determined as non-registered.

b) may comprise b-3) displaying all of face images that are already registered in the database with respect to the person whose face image is to be registered to the database.

The face images displayed in b-3) may be thumbnail images.

The method may further comprise: d) detecting a face from the photographed image; and e) determining whether the person corresponding to the detected face is registered in the database.

In b), a direction of the face image that is not registered to the database with respect to the person corresponding to the detected face in e) may be displayed to the photographer.

e) may comprise: e-1) determining a direction of a face included in the photographed image; and e-2) registering the photographed image when a direction of a face image of the photographed image is different from a direction of the face image registered in the database.

The database may be capable of registering face images photographed from the front side, and from above, below, left, and right of the person.

According to another aspect of the invention, there is provided a computer readable recording medium having embodied thereon a program for executing the above-described method.

### BRIEF DESCRIPTION OF THE DRAWINGS

The above and other features and advantages of embodiments of the invention will become more apparent by describing in detail exemplary embodiments thereof with reference to the attached drawings in which:

FIG. 1 is a block diagram illustrating a digital photographing apparatus according to an embodiment of the invention;

FIG. 2 is a schematic view of information about persons and face images registered to a database according to an embodiment of the invention;

FIG. 3 is a schematic view illustrating an example of displaying a non-registered direction of a face image by using a photographing guide unit, according to an embodiment of the invention;

FIG. 4 is a schematic view illustrating a non-registered direction of a face image by using a photographing guide unit, according to another embodiment of the invention;

FIG. 5 is a flowchart illustrating a method of controlling a digital photographing apparatus according to an embodiment of the invention;

FIG. 6 is a flowchart illustrating a method of controlling a digital photographing apparatus according to another embodiment of the invention;

FIG. 7A is a flowchart illustrating a method of controlling a digital photographing apparatus displaying a non-registered direction of a face image, according to an embodiment of the invention;

FIG. 7B is a flowchart illustrating a method of controlling a digital photographing apparatus displaying a non-registered direction of a face image, according to another embodiment of the invention; and

FIG. 8 is a flowchart illustrating a method of controlling a digital photographing apparatus according to another embodiment of the invention.

### DETAILED DESCRIPTION

The invention will now be described more fully with reference to the accompanying drawings, in which exemplary embodiments of the invention are shown.

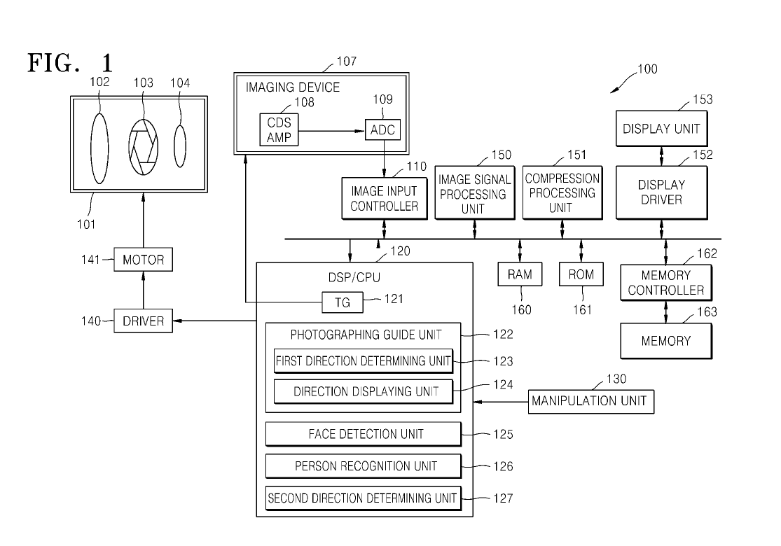

FIG. 1 is a block diagram illustrating a digital photographing apparatus 100 according to an embodiment of the invention.

Referring to FIG. 1, the digital photographing apparatus 100 may include an imaging optical system 101, an imaging device 107, an image input controller 110, a digital signal processor (DSP)/central processor unit (CPU) 120, a manipulation unit 130, a driver 140, a motor 141, an image signal processing unit 150, a compression processing unit 151, a display driver 152, a display unit 153, a random access memory (RAM) 160, a read only memory (ROM) 161, a memory controller 162, and a memory 163.

The imaging optical system 101 is formed of a lens group including a zoom lens 102, a focus lens 104, and an aperture 103. The imaging optical system 101 is an optical system that converts external light information to an image on the imaging device 107. Light is transmitted from a subject to the imaging device 107. The zoom lens 102 varies a focal distance to change an angle of view. The aperture 103 adjusts an amount of light being transmitted. The focus lens 104 adjusts a focal point on a subject on an imaging plane of the imaging device 107 by moving in an optical axis direction. The zoom lens 102, the aperture 103, and the focus lens 104 are driven by the motor 141. In FIG. 1, one driver 140 and one motor 141 are illustrated but the zoom lens 102, the aperture 103, and the focus lens 104 may each include a driver and a motor. The motor 141 is driven by receiving a driving signal from the driver 140.

The imaging device 107 is an example of a photoelectric conversion device, and is formed of a plurality of photoelectric devices that convert light that is incident through the imaging optical system 101 into an electrical signal. Each of the devices generates an electric signal according to received light. Examples of the imaging device 107 are a charge coupled device (CCD) and a complementary metal oxide semiconductor (CMOS) sensor.

Furthermore, in order to control exposure time of the imaging device 107, a mechanical shutter (not shown) or an electronic shutter (not shown) may be used such that light is blocked when photographing is not performed and light is transmitted when photographing an image.

Also, the imaging device 107 may include a correlated double sampling (CDS)/amplifier (AMP) unit 108 and an analog digital converter (ADC) 109. The CDS/AMP unit 108 removes low frequency noise contained in an electrical signal output from the imaging device 107 and amplifies the electrical signal up to a predetermined level at the same time. The ADC 109 converts an electrical signal output from the CDS/AMP unit 108 into a digital signal. The ADC 109 outputs the generated digital signal to the image input controller 110.

The image input controller 110 processes the digital signal output from the ADC 109 to generate an image signal to which image signal processing is possible. The image input controller 110 outputs the generated image signal to, for example, the image signal processing unit 150. Also, the image input controller 110 controls reading and writing of image data from the RAM 160.

The optical imaging system 101, the imaging device 107, and the image input controller 110 may be examples of a photographing unit that generates an image signal by photographing an image of a subject.

A database (not shown) stores information about a person and a face image with respect to the person. The database may include information about a plurality of persons, and a new person may be registered to the database or a person may be deleted from the database. Also, person information with respect to one person and a plurality of face images of the person may be registered to the database. The plurality of face images may be images that are photographed from various directions. For example, a face image photographed from the front side, and face images photographed from above, below, left, and right directions. The database may be implemented by using the ROM 161 or the memory 163 which will be described later.

The DSP/CPU 120 functions as a calculation processor and a controller according to methods and controls processing of elements installed in the digital photographing apparatus 100. The DSP/CPU 120 outputs a signal to the driver 140 based on, for example, focus controlling or exposure controlling, to drive the imaging optical system 101. Also, the DSP/CPU 120 controls elements of the digital photographing apparatus 100 based on a signal transmitted from the manipulation unit 130. The DSP/CPU 120 may include a timing generator (TG) 121 that outputs a timing signal to the CDS/AMP 108 and controls an exposure period of pixels of the imaging device 107 or reading of charges.

Also, the DSP/CPU 120 may include a photographing guide unit 122, a face detection unit 125, and a person recognizing unit 126.

The photographing guide unit 122 is configured to display a direction of a face image that is not registered in the database. The photographing guide unit 122 may display the direction while photographing an image. The photographing guide unit 122 may guide the photographer to capture images of the face of a person, who is to be registered in the database, in multiple directions so that the captured images of the face in multiple directions can be registered in the database.

When registering face images of a certain person in a face registration mode, the photographing guide unit 122 may display all of face images that are already registered in the database on a portion of the display unit 153. For example, the photographing guide unit 122 may extract face images from a database and reduce the size of the face images to create thumbnail images. The photographing guide unit 122 may display the generated thumbnail images on a portion of the display unit 153, for example, on a left lower end. Thus, the photographer may easily check a direction of face images that are already registered in the database and photograph a face image in a new direction so that it can be registered in the database. Thus, the photographing guide unit 122 may assist the photographer in capturing and registering images of a face captured from different directions.

According to another embodiment, the photographing guide unit 122 may include a first direction determining unit 123 and a direction display unit 124.

The first direction determining unit 123 determines a non-registered direction of a face image of a person who is to be registered to the database. For example, when a face image that is photographed from the front side with respect to the person and a face image photographed from the right side are already stored in the database, the first direction determining unit 123 determines that face images of the person photographed from above and below and from the left side are not registered.

The direction display unit 125 displays a direction of a face image that is determined as a non-registered direction. Displaying of the direction may be implemented by generating a graphic user interface (GUI) and displaying the same on the display unit 153. For example, when a face image photographed from the front side and a face image photographed from the left side with respect to a person to register are registered to the database, a GUI informing the photographer of this registration may be displayed together with a live-view image.

Meanwhile, the DSP/CPU 120 of the digital photographing apparatus 100 may further include a face detection unit 124 and a person recognition unit 125.

The face detection unit 124 detects a face included in the photographed image from an image signal generated by photographing a subject by using the photographing unit. When the face detection unit 124 detects a face, face information with respect to the person of the detected face may be generated. That is, data that characterizes the person of the detected face, for example, positions of eyes, nose, or mouth may be generated.

The person recognition unit 125 determines whether the person corresponding to the detected face is registered to the database. That is, the person recognition unit 125 matches face information generated by face detection of the face detection unit 124 with face information stored in the database to determine whether the person corresponding to the detected person is in the database. The person recognition unit 125 may match face information using data that characterizes the person and/or may determine whether the person is stored in the database by attempting to match the face with multiple directions of the face stored in the database.

When the person being photographed is determined to be registered in the database, by the face detection unit 124 and the person recognition unit 125, the photographing guide unit 122 may display a direction of a face image that is not registered to the database with respect to the person, to the photographer.

Also, the DSP/CPU 120 of the digital photographing apparatus 100 may further include a second direction determining unit 127 (not shown).

The second direction determining unit 127 determines a direction of a face included in an image photographed by the photographing unit. The direction of the face may be determined by angles, and in detail, by measuring how much has been rotated from the position where the face faces the front. For example, if the face is determined to have been rotated by 30 degree to the left compared to when the face faces the front, the face image may be determined as an image photographed from the right side. However, although a direction that is not registered in the database has been displayed to the user, a face image in the same direction may be photographed again. In this case, whether the direction of a face image photographed by the second direction determining unit 127 is different from the direction of a face image registered to the database may be determined. If the direction of the face of the photographed image is different from the direction of the face image registered to the database, an image photographed by an image registering unit, which is to be described later, may be registered to the database. On the other hand, if the direction of the face of the photographed image is in the same direction of the face image registered to the database, the photographed image may not be registered but denotations such as ‘THE IMAGE IS IN ALREADY REGISTERED DIRECTION’ or ‘PHOTOGRAPH IMAGE IN DIFFERENT DIRECTION’ may be displayed. In embodiments, the photographer may be offered the option of replacing the currently registered image of the face with a direction with the photographed image.

The manipulation unit 130 is a unit through which various commands from the user are input for manipulating the digital photographing apparatus 100. The manipulation unit 130 may include, for example, a power button, a shutter-release button, various functional buttons, etc.

The RAM 160 is a storage unit for temporarily storing various data. Although not shown in the drawing, the RAM 160 may include a video RAM (VRAM) as an image-displaying memory and a synchronous DRAM (SDRAM) for temporarily storing image data of a photographed image.

In the ROM 161, various set up data of the user such as photographing conditions may be stored. Also, methods used by the DSP/CPU 120 to control the digital photographing apparatus 100 may be stored in the ROM 161. According to the current embodiment, face detection and face recognition methods may be stored in the ROM 161.

The memory controller 162 controls writing of image data to the memory 163, or reading of image data or set up information written to the memory 163. That is, the memory controller 162 may be an example of an image register unit. The image register unit may register a photographed image to the memory 163 only when a direction of a face included in an image photographed by the DSP/CPU 120 is different from the direction of the face image registered to the database. The memory 163 may be, for example, an optical disk such as CD, DVD, blue-ray disk, etc., an optical magnetic disk, a magnetic disk, a semiconductor storage medium, etc. to which the photographed image data is written. The image data may be an image file generated by the compression processing unit 151. The memory controller 162 and the memory 163 may also be detachable from the digital photographing apparatus 100.

The ROM 161 or the memory 163 may store information about a person and face information of the person. Accordingly, the ROM 161 or the memory 163 may be an example of database.

The image signal processing unit 150 receives an image signal from the image input controller 110 to generate an image signal to which image processing is performed, based on a white balance adjusting gain value, a y value, an outline emphasis control value, or the like.

The compression processing unit 151 receives an image signal to which image signal processing is performed, and compresses the image signal in a compression format such as a JPEG compression format or a H.264 format. The compression processing unit 151 transmits the image file including image data generated by compression to, for example, the memory controller 161.

The display driver 152 receives image data from, for example, the RAM 160, and displays the image to the display unit 153. The image displayed by the display unit 153 may be, for example, an image which is read from the RAM 160 and is not photographed yet (live-view image), a screen of various setups of the digital photographing apparatus 100, an image of an image file that is photographed and recorded. Also, the display unit 153 may display a GUI generated by the direction display unit 124 to inform the photographer of a non-registered direction of a face image. Alternatively, as described above, the display unit 153 may display thumbnail images that are generated by extracting a face image that is registered to the database. The display unit 153 and the display driver 152 may respectively be a liquid crystal display (LCD) and an LCD driver but are not limited thereto, and may also be an OLED and an OLED driver.

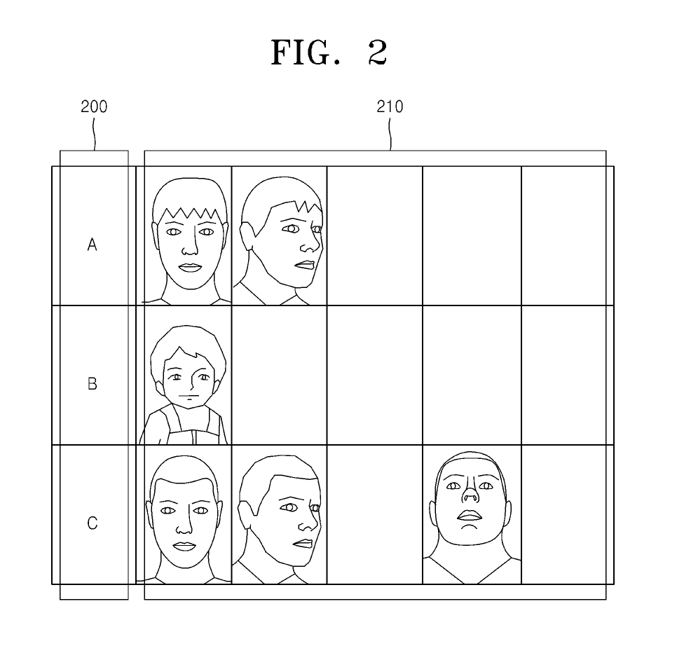

FIG. 2 is a schematic view of information about persons and face images registered to a database according to an embodiment of the invention.

Referring to FIG. 2, in the database, person information 200 and face images 210 corresponding to the person information 200 are registered in tables. A plurality of face images 210 may be registered. In detail, with respect to a person A, face images photographed from the front and the left sides are registered. For the person B, a face image photographed from the front is registered. Also, for the person C, face images photographed from the front, the left side, and the right side are registered. According to the current embodiment, the face images registered with respect to one person each need to be images that are photographed from various directions and the directions may include the front side and from above, below, left, and right side. To this end, the digital photographing apparatus 100 may determine the direction of the face included in the image photographed before registering the photographed face image to the database. A photographed face image may be registered to the database only when the direction of the face included in the photographed image is different from the direction of the face image that is previously registered according to the determination.

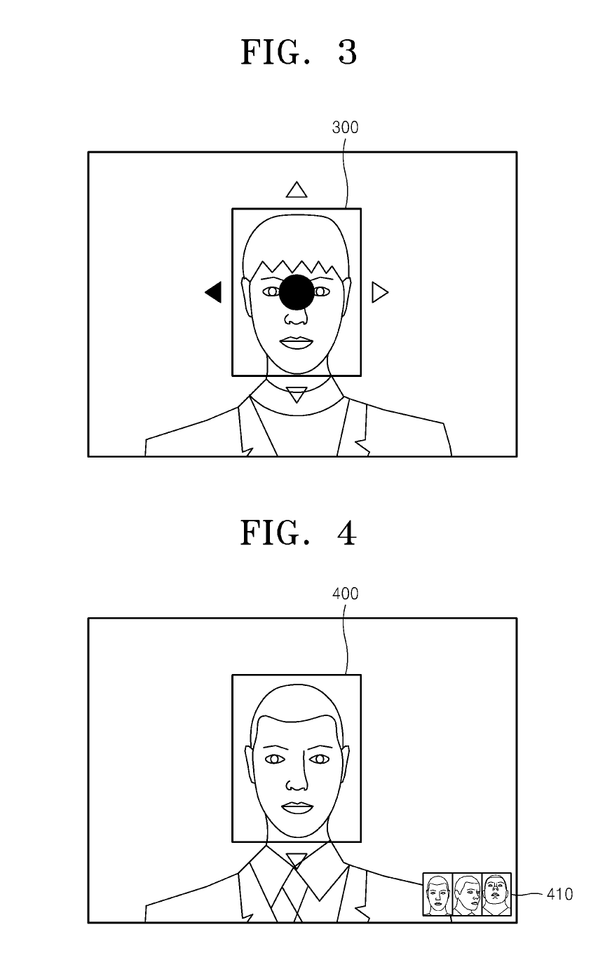

FIG. 3 is a schematic view illustrating an example of displaying a non-registered direction of a face image by using a photographing guide unit, according to an embodiment of the invention.

Referring to FIG. 3, a focal point frame 300 may be displayed on a liveview image, and the direction display unit 124 displays triangle-shaped GUIs in four directions on outer portions of the focal point frame 300. The first direction determination unit 123 determines directions of face images registered to the person A. According to the current embodiment, the person A is photographed, and face images photographed from the front and left sides are registered with respect to the person A (and face images are not registered for top, bottom and right sides). Accordingly, the direction display unit 124 colors inner portions of the triangle-shaped GUI disposed on the left side of the focal point frame 300, and displays a predetermined mark on the front of the face of the person A, for example, a circle with colored inside.

As described above, by determining the directions of the face images that are already registered with respect to a person to register to the database and displaying the same to the photographer, the photographer may easily photograph a face image in a new direction.

FIG. 4 is a schematic view illustrating a non-registered direction of a face image by using a photographing guide unit, according to another embodiment of the invention.

Referring to FIG. 4, a focal point frame 400 may be displayed on a liveview image, and small thumbnail images 410 may be displayed on a lower right end of the liveview image. According to the current embodiment, the person C is being photographed, and face images of the person C photographed from the front side, the left side, and from below are registered in the database. Accordingly, the photographing guide unit 122 extracts face images that are registered already in the database to generate the thumbnail images 410, and displays the same with the liveview image.

As described above, by determining directions of the face images that are already registered in the database with respect to the person to register in the database, the photographer may easily photograph a face image in a new direction.

Meanwhile, the person to be registered to the database regarding FIGS. 3 and 4 may be directly selected by the user in a person registration mode or automatically by face detection or person recognition.

As described above, the digital photographing apparatus 100 according to the current embodiment of the invention may register a face image that is photographed with respect to one person in various directions. Thus, improved person recognition is possible when performing a person recognition function.

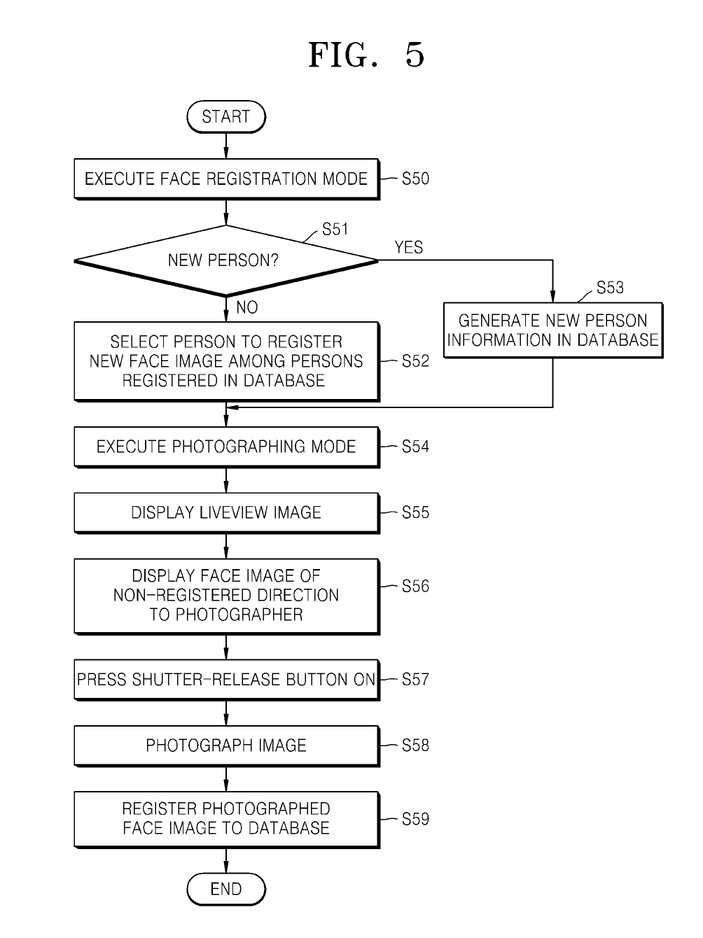

FIG. 5 is a flowchart illustrating a method of controlling a digital photographing apparatus according to an embodiment of the invention. According to the current embodiment, a face registration mode is directly performed by manipulation of the user.

First, a face registration mode is performed by manipulation of the user in operation S50. Next, whether a new person is to be registered is determined in operation S51, and if a face image with respect to a previously registered person is to be registered, a person whose new face is to be registered is selected among persons registered in the database in operation S52. On the other hand, when registering a new person, new person information is created in the database in operation S53.

In operation S54, when a person whose face image is to be registered is determined in operation S52 or operation S53, a photographing mode is executed in operation S54. As the photographing mode is executed, an image of a subject is photographed to generate an image signal, and a liveview image is displayed on the display unit by using the image signal in operation S55. In operation S56, while displaying the liveview image, a face image in a non-registered direction is displayed to the photographer at the same time. When a shutter-release button on signal is applied by the photographer in operation S57, an image is photographed in operation S58. That is, an image is captured, thereby generating an image file.

In operation S59, the photographed face image is registered to the database.

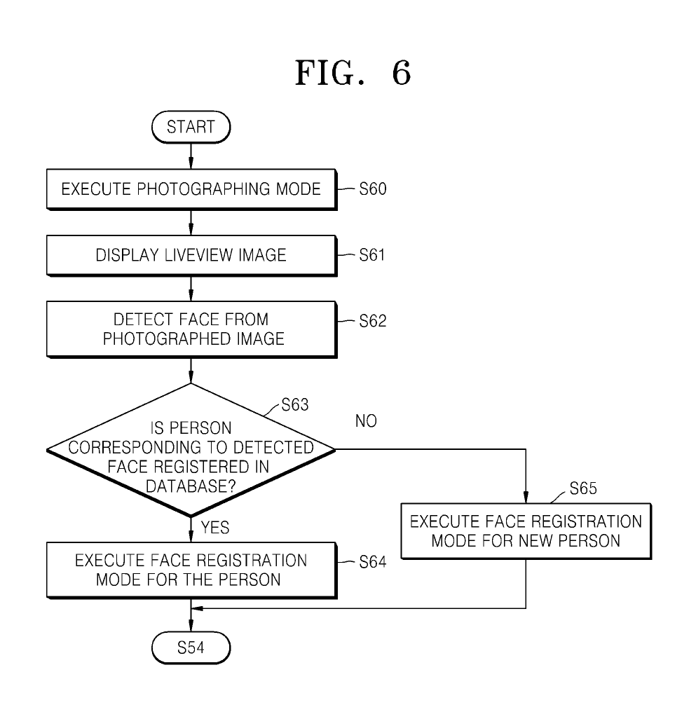

FIG. 6 is a flowchart illustrating a method of controlling a digital photographing apparatus according to another embodiment of the invention. According to the current embodiment, a face registration mode is executed by performing face detection and person recognition in a photographing mode.

First, in operation S60, a photographing mode is executed in the digital photographing apparatus 100. In operation S61, an image signal is generated by photographing an image of a subject by execution of the photographing mode, and a liveview image is displayed on the display unit by using the image signal.

In operation S62, face detection is performed based on the photographed image, and whether the person corresponding to the detected face is registered in the database is determined in operation S63. That is, person recognition is performed.

In operation S64, if the detected face is of a person registered in the database, a face registration mode is executed with respect to the recognized person, and if the detected face is of a new person, a face registration mode with respect to the new person is executed in operation S65.

When a face registration mode is executed in operation S64 or in operation S65, the method proceeds to operation S54 to thereby register the face image to the database.

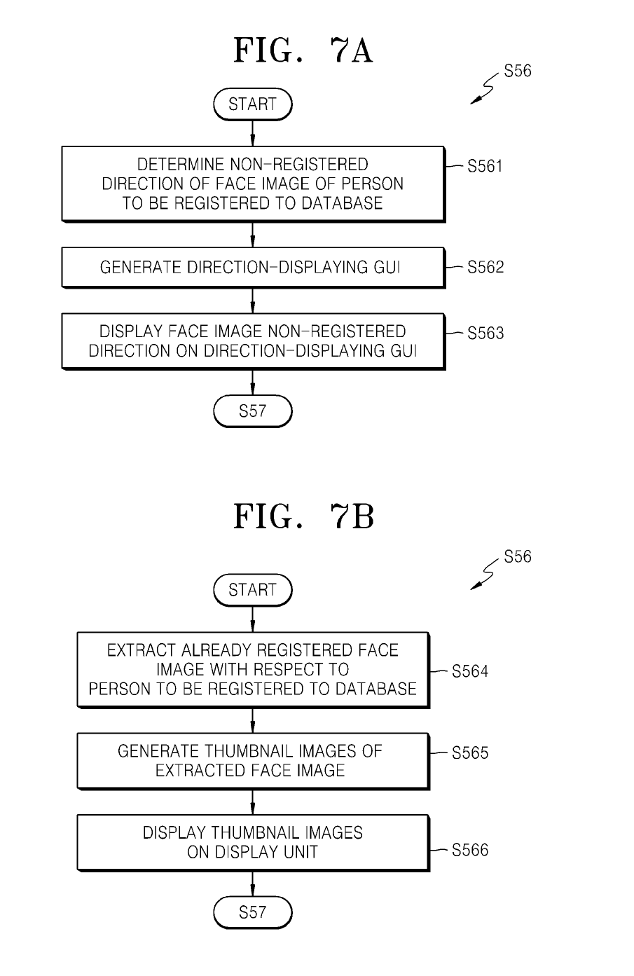

Next, referring to FIGS. 7A and 7B, a method of displaying a non-registered direction of a face image will be described.

FIG. 7A is a flowchart illustrating a method of displaying a non-registered direction of a face image, by creating a direction-displaying GUI according to an embodiment of the invention.

In operation S561, when a person to be registered is determined by a face registration mode or by face detection and person recognition and a photographing mode is executed again, a non-registered direction of a face image with respect to the person to be registered is determined in the database in operation S561.

In operation S562, a direction-displaying GUI is generated according to a result of the determination, and in operation S563, a non-registered direction is displayed on the direction-displaying GUI. An embodiment of how the non-registered direction is displayed is described in detail with reference to FIG. 3, and thus description thereof will be omitted.

FIG. 7B is a flowchart illustrating a method of displaying a non-registered direction of a face image by creating thumbnail images, according to another embodiment of the invention.

In operation S564, when a person to be registered is determined by a face registration mode or by face detection and person recognition and a photographing mode is executed again, a previously registered face image with respect to the person to be registered to the database is extracted.

In operation S565, thumbnail images are created by using the extracted face image, and in operation S565, the thumbnail images are displayed on a display unit. An embodiment of displaying thumbnail images is described in detail above with reference to FIG. 4, and thus description thereof will be omitted.

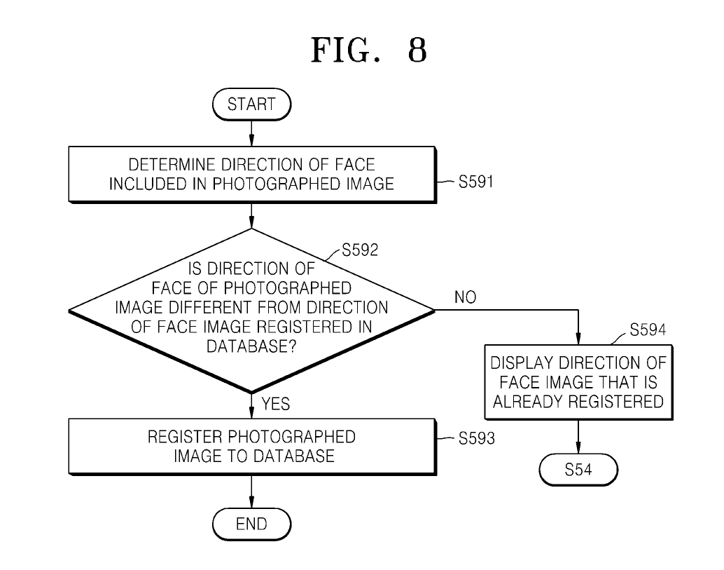

FIG. 8 is a flowchart illustrating a method of controlling a digital photographing apparatus according to another embodiment of the invention.

Referring to FIG. 8, when photographing an image, a direction of a face included in the photographed image is determined before registering the image to the database in operation S591. The direction of the face may be determined by angles. For example, if the face is determined to be rotated by 30 degree to the left side compared to when the face faces the front side, the face may be determined as a face image photographed from the right side.

In operation S592, when determining a direction of the face of the photographed image, whether the direction of the face is different from a direction of a face image registered in the database is determined. A person recognition rate can be increased when face images photographed in various directions are registered.

In operation S593, if the direction of the face of the photographed image and the direction of the face image already registered to the database are different, the photographed image is registered to the database.

On the other hand, if the direction of the face of the photographed image is the same as the direction of the face image already registered in the database, it is displayed to the user that the image is the face image of the already registered direction in operation S594, and the method goes back to operation S54 to photograph a face image again. In embodiments, the user is offered the option of replacing the photograph in database with the new photograph.

As described above, according to the method of controlling the digital photographing apparatus 100 according to the embodiments of the invention, face images photographed in various directions with respect to one person may be registered. Accordingly, a person can be exactly recognized when performing a person recognition function.

Methods for executing the method of controlling the digital photographing apparatus 100 according to the embodiments of the invention in the digital photographing apparatus may be stored in a recording medium. The recording medium may be the memory 163 as illustrated in FIG. 1 or other recording media. Examples of the recording medium include magnetic storage media (e.g., hard disks, etc.), optical recording media (e.g., digital versatile discs (DVDs)). The recording media may be limited to physical media.

The various illustrative logics, logical blocks, modules, units, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

Additionally, the illustrative units discussed above may be organized differently so that the functions implemented by one unit may be implemented by more than one unit and/or the functions implemented by two or more units may be implemented by fewer than two or more units. Moreover, there may be no units.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A digital photographing apparatus comprising:
a database configured to store information about a person and to store a plurality of images of the face of the person with a direction of the face;
a photographing unit configured to photograph an image of the face of the person;
an image registering unit configured to store the photographed image of the face of the person with the database according to the direction of the face; and
a photographing guide unit configured to display a direction of the face of the person not stored in the database.

2. The digital photographing apparatus of claim 1, wherein the photographing guide unit comprises:
a first direction determining unit configured to determine directions of the face that are not stored in the database; and
a direction display unit configured to display the directions of the face that are not stored in the database.

3. The digital photographing apparatus of claim 1, wherein the photographing guide unit is configured to display a plurality of stored photographed images of the face according to the direction of the face.

4. The digital photographing apparatus of claim 3, wherein the photographing guide unit is configured to display the plurality of stored photographed images of the face as thumbnail images.

5. The digital photographing apparatus of claim 1, further comprising:
a face detection unit configured to detect the face in the photographed image of the face of the person; and
a person recognition unit configured to determine whether the person is stored in the database.

6. The digital photographing apparatus of claim 5, wherein the photographing guide unit is configured to display a direction of the face that is not stored in the database.

7. The digital photographing apparatus of claim 1, further comprising a second direction determining unit configured to determine the direction of the face of the photographed image, and
wherein the image registering unit is configured to store the photographed image of the face if the direction of the face of the photographed image is not stored in the database.

8. The digital photographing apparatus of claim 1, wherein the direction of the face comprises a front, above, below, left, and right all with respect to the face of the person.

9. A method of controlling a digital photographing apparatus comprising a database comprising information about a person and a face image of the person, capable of storing a plurality of face images of the person photographed in different directions, the method comprising:
a) photographing an image of a subject;
b) displaying a non-registered direction of a face image in the database, to the photographer; and
c) registering the photographed image to the database.

10. The method of claim 9, wherein b) comprises:
b-1) determining a non-registered direction of a face image with respect to a person whose face image is to be registered to the database; and
b-2) displaying a direction of the face image that is determined as non-registered.

11. The method of claim 9, wherein b) comprises b-3) displaying all of face images that are already registered in the database with respect to the person whose face image is to be registered to the database.

12. The method of claim 11, wherein the face images displayed in b-3) are thumbnail images.

13. The method of claim 9, further comprising:
d) detecting a face from the photographed image; and
e) determining whether the person corresponding to the detected face is registered in the database.

14. The method of claim 13, wherein in b), a direction of the face image that is not registered to the database with respect to the person corresponding to the detected face in e) is displayed to the photographer.

15. The method of claim 9, wherein e) comprises:
e-1) determining a direction of a face included in the photographed image; and
e-2) registering the photographed image when a direction of a face image of the photographed image is different from a direction of the face image registered in the database.

16. The method of claim 9, wherein the database is capable of registering face images photographed from the front side, and from above, below, left, and right of the person.

17. A computer readable recording medium having embodied thereon a program for executing the method of claim 9.

18. A computer readable recording medium having embodied thereon a program for executing the method of claim 10.

19. A computer readable recording medium having embodied thereon a program for executing the method of claim 13.

20. A computer readable recording medium having embodied thereon a program for executing the method of claim 15.
